(19) United States
(12) Patent Application Publication
(10) Pub. No.: US 2018/0253515 A1
(43) Pub. Date: Sep. 6, 2018

(54) CHARACTERIZING MODEL PERFORMANCE USING HIERARCHICAL FEATURE GROUPS

(71) Applicant: LinkedIn Corporation, Sunnyvale, CA (US)

(72) Inventor: Wei Di, Cupertino, CA (US)

(73) Assignee: LinkedIn Corporation, Sunnyvale, CA (US)

(21) Appl. No.: 15/448,871

(22) Filed: Mar. 3, 2017

(51) Int. Cl. G06F 17/50; G06F 17/18

(52) U.S. Cl. CPC G06F 17/5009; G06F 2217/16; G06F 17/18

(57) ABSTRACT

The disclosed embodiments provide a system for processing data. During operation, the system uses a hierarchical structure of features inputted into a statistical model to obtain a set of groups of the features. Next, the system uses the groups as input to a set of view models for estimating an output of the statistical model. The system then applies the view models to the features to generate a set of view model outputs, wherein each view model output in the set of view model outputs represents an effect of a group in the set of groups on an output of the statistical model. Finally, the system outputs the view model outputs for use in characterizing a performance of the statistical model.

### BACKGROUND

### Field

The disclosed embodiments relate to statistical model performance. More specifically, the disclosed embodiments relate to techniques for characterizing model performance using hierarchical feature groups.

### Related Art

Analytics may be used to discover trends, patterns, relationships, and/or other attributes related to large sets of complex, interconnected, and/or multidimensional data. In turn, the discovered information may be used to gain insights and/or guide decisions or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of statistical models. The discovered information may then be used to guide decisions and/or perform actions related to the data. For example, the output of a statistical model may be used to guide marketing decisions, assess risk, detect fraud, predict behavior, and/or customize or optimize use of an application or website.

However, significant time, effort, and overhead may be spent on feature selection during creation and training of statistical models for analytics. For example, a data set for a statistical model may have thousands to millions of features, including features that are created from combinations of other features, while only a fraction of the features and/or combinations may be relevant and/or important to the statistical model. At the same time, training and/or execution of statistical models with large numbers of features typically require more memory, computational resources, and time than those of statistical models with smaller numbers of features. Excessively complex statistical models that utilize too many features may additionally be at risk for overfitting.

At the same time, statistical models are commonly associated with a tradeoff between interpretability and performance. For example, a linear regression model may include coefficients that identify the relative weights or importance of features in the model but does not perform well with complex problems. Conversely, a nonlinear model such as a random forest or gradient boosted trees can be trained to perform well with a variety of problems but typically operates in a way that is not easy to understand.

Consequently, creation and use of statistical models in analytics may be facilitated by mechanisms for efficiently and effectively performing feature selection and interpretation for the statistical models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows an exemplary hierarchical structure of features used as input to a statistical model in accordance with the disclosed embodiments.

FIG. 4 shows an exemplary screenshot in accordance with the disclosed embodiments.

FIG. 5 shows a flowchart illustrating the processing of data in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

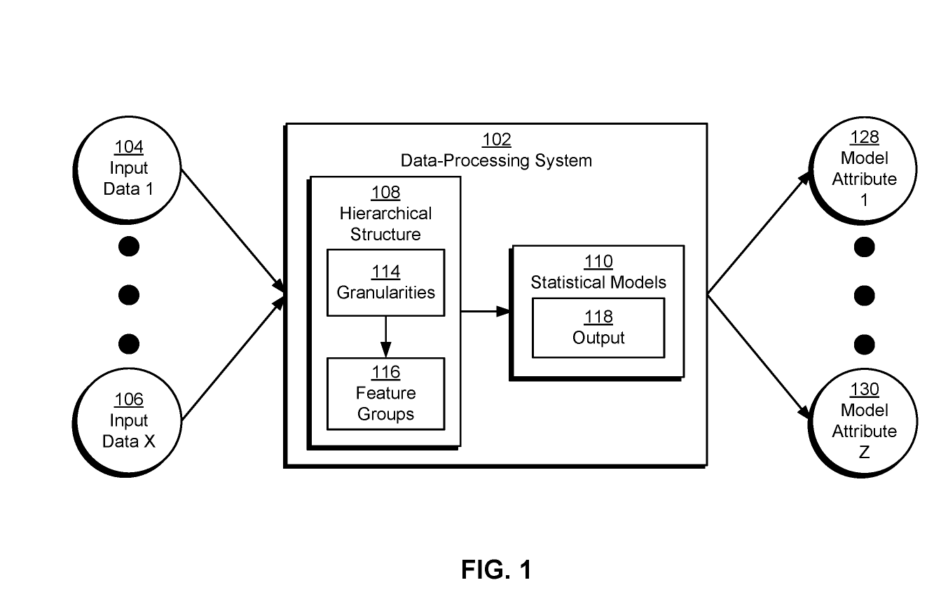

The disclosed embodiments provide a method, apparatus, and system for processing data. As shown in FIG. 1, the system may be a data-processing system 102 that analyzes one or more sets of input data (e.g., input data 1 104, input data x 106). More specifically, data-processing system 102 may create and train one or more statistical models 110 for analyzing input data related to users, organizations, applications, job postings, purchases, electronic devices, network devices, images, audio, video, websites, content, sensor measurements, and/or other categories. The statistical models may include, but are not limited to, regression models, artificial neural networks, support vector machines, decision trees, random forests, boosted gradient trees, naïve Bayes classifiers, Bayesian networks, hierarchical models, and/or ensemble models.

Analysis performed by data-processing system 102 may be used to discover relationships, patterns, and/or trends in the data; gain insights from the input data; and/or guide decisions or actions related to the data. For example, the data-processing system may use statistical models 110 to generate output 118 that includes scores, classifications, recommendations, estimates, predictions, and/or other inferences or properties. The output may be inferred or extracted from primary features in the input data and/or derived features that are generated from primary features and/or other derived features. For example, the primary features may include profile data, user activity, sensor data, and/or other data that is extracted directly from fields or records in the input data. The primary features may be aggregated, scaled, combined, bucketized, and/or otherwise transformed to produce derived features, which in turn may be further combined or transformed with one another and/or the primary features to generate additional derived features. After output is generated from one or more sets of primary and/or derived features, the output may be queried and/or used to improve revenue, interaction with the users and/or organizations, use of the applications and/or content, and/or other metrics associated with the input data.

Data-processing system 102 may also use a hierarchical structure 108 of the features to generate a set of feature groups 116 and characterize the performance of statistical models 110 using the feature groups. As described in further detail below, feature groups in the hierarchical structure may be generated based on different granularities 114 associated with the feature. For example, features used as input to a statistical model may be grouped along semantic and/or correlative lines, with a higher granularity in the hierarchical structure used to generate more feature groups and a lower granularity in the hierarchical structure used to produce fewer feature groups. In turn, the feature groups may be used as input to individual view models that characterize the effect of the feature groups on the output of the statistical model. Outputs from the view models may further be used as input to a secondary model that estimates output 118 of the statistical model, and model attributes (e.g., model attribute 1 128, model attribute z 130) associated with the view models and/or secondary model may be used to characterize and/or understand the operation or performance of the statistical model.

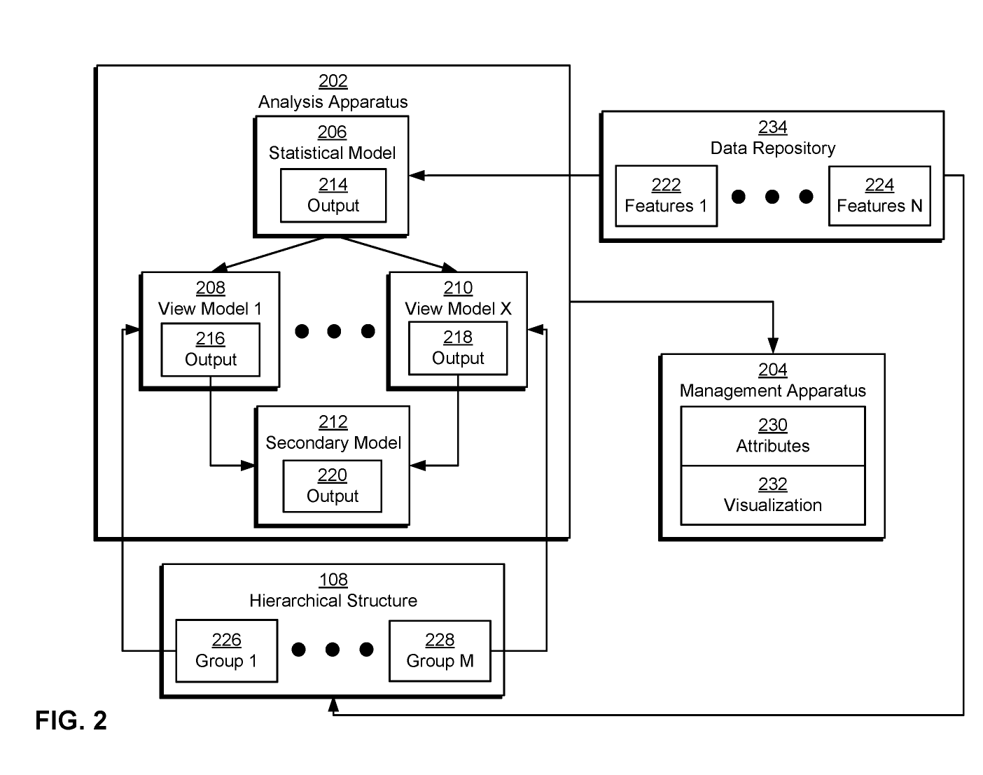

FIG. 2 shows a system for processing data, such as data-processing system 102 of FIG. 1, in accordance with the disclosed embodiments. The system includes an analysis apparatus 202 and a management apparatus 204. Each of these components is described in further detail below.

Analysis apparatus 202 may perform processing related to characterizing the performance or operation of a statistical model 206. For example, the analysis apparatus may obtain the statistical model as a regression model, artificial neural network, naïve Bayes classifier, Bayesian network, clustering technique, decision tree, random forest, gradient boosted tree, support vector machine, and/or other type of machine learning model or technique. Output 214 of the statistical model may be used to perform prediction, classification, scoring, recommendation, estimation, and/or other tasks. For example, the statistical model may generate scores that represent propensities of users in performing an action and/or of customers in purchasing a product.

As shown in FIG. 2, statistical model 206 may be trained and/or executed using multiple sets of features (e.g., features 1 222, features n 224). The features may be stored in a database, data store, distributed filesystem, messaging service, and/or another type of data repository 234. During training, the statistical model may be fit to a subset of the features. The statistical model may then be validated and/or tested using one or more additional subsets of the features. Finally, the statistical model may be applied to new and/or remaining subsets of features in the data repository to generate output 214 that infers properties associated with the features.

Those skilled in the art will appreciate that a number of factors associated with features inputted into statistical model 206 may influence output 214 of the statistical model and/or interfere with interpreting the performance of the statistical model. First, the range of possible values in a given feature may be reflected in the corresponding weight and/or measure of importance of the feature. For example, the impurity decrease in a random forest may be biased toward features with larger numbers of categories. In another example, a regression coefficient for a given feature may decrease as the range of values for the feature increases.

Second, measures of feature importance may be affected by correlations among variables and/or noise in statistical model 206. For example, the statistical model may be trained such that regression coefficients and/or other weights representing feature importance may be distributed among multiple correlated features. Conversely, training of the statistical model may produce weights that overemphasize the importance of a single feature in a set of correlated features. In another example, large amounts of noise in individual features may interfere with accurately analyzing the performance of the statistical model with respect to the features.

Third, conventional model interpretation techniques do not scale with the number of features in statistical model 206. For example, a model with tens of thousands of features may be analyzed conventionally with respect to individual features, even when some of the features do not contribute meaningfully to the output of the model. Such single feature interpretation may additionally result in high computational overhead and negatively impact understanding of the overall operation of the model.

In one or more embodiments, the system of FIG. 2 includes functionality to perform analysis and interpretation of statistical model 206 using a hierarchical structure 108 of features inputted into the statistical model. Each tier of the hierarchical structure may group the features along a different granularity. For example, the lowest tier may include the highest number of feature groups (e.g., group 1 226, group m 228) and/or the most groups containing individual features, and the highest tier may include the lowest number of groups and a higher average number of features in each group than lower tiers of the hierarchical structure. The number of groups in each tier of the hierarchical structure may be manually set, determined according to a formula (e.g., based on the number of tiers and/or features), and/or generated according to the technique used to group the features.

Analysis apparatus 202 and/or another component of the system may generate hierarchical structure 108 based on semantic groupings of the features and/or correlations among the features. For example, the component may group the features based on sources of the features, metadata associated with the features, input from users or teams associated with the features, and/or other information related to the types or meanings associated with the features. The component may also, or instead, determine correlations among the features and generate the feature groups so that features within the same group are more highly correlated than features in different groups. If a particular feature is identified as important or useful to interpreting the performance of statistical model 206 (e.g., by a user associated with creating the feature and/or using output 214 of the statistical model), the component may generate a group that includes only the feature. After the hierarchical structure is generated, the hierarchical structure may optionally be stored in data repository 234 and/or another repository for subsequent retrieval and use.

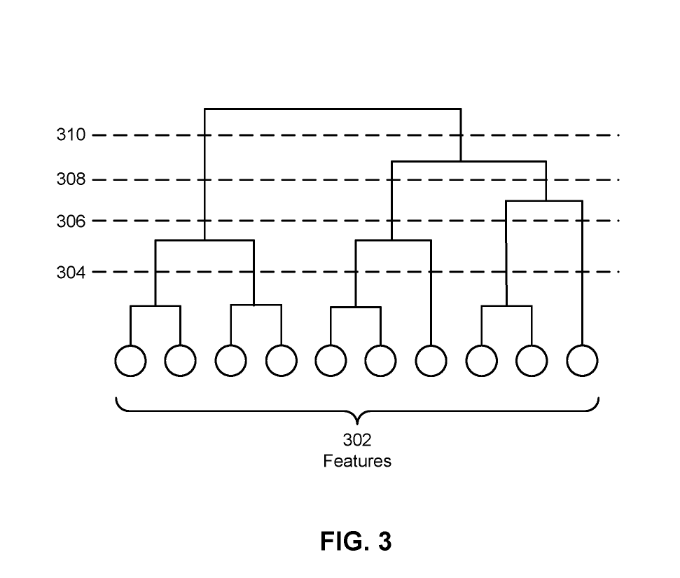

Because related features are grouped together in hierarchical structure 108, each group may represent a different “view” of statistical model 108. For example, a statistical model that is used to predict the purchasing or churn behavior of customers of a product may include features that are grouped into views related to product usage, historic spending, advertising or marketing, and/or customer demographics. In another example, a clustering technique may be applied to similar types of features (e.g., rates, frequencies, occurrences, Boolean values) so that features that are highly correlated are assigned to the same group and features that are not highly correlated are separated into different groups. Hierarchical structures containing groups of features used as input to statistical models are described in further detail below with respect to FIG. 3.

After hierarchical structure 108 is generated, analysis apparatus 202 may select a set of groups of features from the hierarchical structure for use in analyzing the performance of statistical model 206. For example, the analysis apparatus may select a set of feature groups from one or more tiers of the hierarchical structure to assess the performance of the statistical model with respect to the corresponding “views.” The number of groups may be selected based on user preferences, computational limits, and/or other factors. The selected feature groups may additionally encompass all features inputted into the statistical model, a subset of the features, and/or feature groups with overlapping features.

Next, analysis apparatus 202 may use the selected feature groups from hierarchical structure 108 to produce a set of view models (e.g., view model 1 208, view model x 210). In particular, the analysis apparatus may use each feature group to train a corresponding view model so that the output (e.g., output 216-218) of the view model estimates output 214 of statistical model 206. A given output value from the view model may thus reflect the contribution of the values in the corresponding feature group to the output of the statistical model.

Analysis apparatus 202 may use outputs 216-218 from the view models as features inputted into a secondary model 212. For example, the analysis apparatus may train the secondary model using the view model outputs so that an output 220 of the secondary model estimates output 214 of statistical model 206. In turn, attributes of secondary model 212 may be used to further characterize the performance and/or output of the statistical model.

An exemplary representation of a view model may include the following:

y= [symbol] ᵢ((f₁, . . . ,fᵢₙ,)ᵢ,θᵢ)

In the above equation, y represents output 214 of statistical model 206, and [symbol] ᵢ represents the view model denoted by i. Input to the view model includes features denoted by f₁, to fᵢₙ, as well as a model parameter θᵢ that defines the view model. For example, the view model may be a linear model that is trained using features in the corresponding feature group to estimate y. After the view model is trained, coefficients of the linear model may be defined or specified in the model parameter θᵢ.

Outputs 216-218 of N view models [symbol] ₁, . . . , [symbol] _{N} may also be aggregated into the following feature space:

[ [symbol] ₁((f₁, . . . ,f₁ₙ,)₁,θ₁), . . . , [symbol] _{N}((f₁, . . . ,f_{Nn},)_{N},θ_{N})]

In other words, a large set of features for statistical model 206 may be transformed by the view models into a lower-dimensional feature space, with each coordinate of the feature space representing a given feature group or “view” of the statistical model.

The feature space may then be used as input to secondary model 212, as represented by Ø:

y=Ø[ [symbol] ₁((f₁, . . . ,f₁ₙ,)₁,θ₁), . . . , [symbol] _{N}((f₁, . . . ,f_{Nn},)_{N},θ_{N})]

After the secondary model is trained, weights and/or other attributes of the secondary model may further be used to characterize the effect of the feature groups on statistical model 206. For example, coefficients of a linear secondary model may represent the correlation between the corresponding feature groups and output 214 of the statistical model. In another example, the impurity decrease associated with each view model output used as input to a random forest secondary model may indicate the correlation between the corresponding feature group and the output of the statistical model.

After the view models and secondary model 212 are produced, analysis apparatus 202 may compare output 220 of the secondary model with output 214 of statistical model 206. If the difference between each the two outputs exceeds a threshold, the analysis apparatus may adjust some or all of the view model outputs 216-218 inputted into the secondary model to compensate for the difference. For example, the analysis apparatus may generate a distribution of differences in the two outputs. If a given value of output 220 differs from the corresponding value of output 214 by more than a certain amount (e.g., 50% of the average difference between the two outputs), the analysis apparatus may iteratively adjust the view model output values used to produce the value of output 220 until the difference falls below the threshold. In another example, the analysis apparatus may use a regression technique to adjust the view model outputs and correct for the difference. In other words, the analysis apparatus may “calibrate” the view model outputs based on the differences to better reflect output 214 of the statistical model.

Finally, management apparatus 204 may output attributes 230 associated with the models and/or outputs for use in characterizing the performance of statistical model 206. The attributes may include values of output 216-218 from the view models, which represent the relative “strength” or contribution of the corresponding groups of feature values to values of output 214 from the statistical model. The attributes may also include coefficients (e.g., linear model coefficients) and/or weights (e.g., random forest impurity decreases) associated with secondary model 212, which represent the overall correlation between the corresponding feature groups and output 214. The attributes may further include coefficients and/or weights from the view models, which represent the correlation between individual features and output 214.

The attributes may be displayed in a table, chart, ranking, and/or other representation within a graphical user interface (GUI), command line interface (CLI), and/or other type of user interface provided by management apparatus 204. The management apparatus may also enable filtering, sorting, and/or grouping of the displayed data by attribute, feature group, data set, and/or other type of value. The management apparatus may further export or store the attributes and/or associated values (e.g., feature groups, data sets, etc.) in a file, database, spreadsheet, and/or other format.

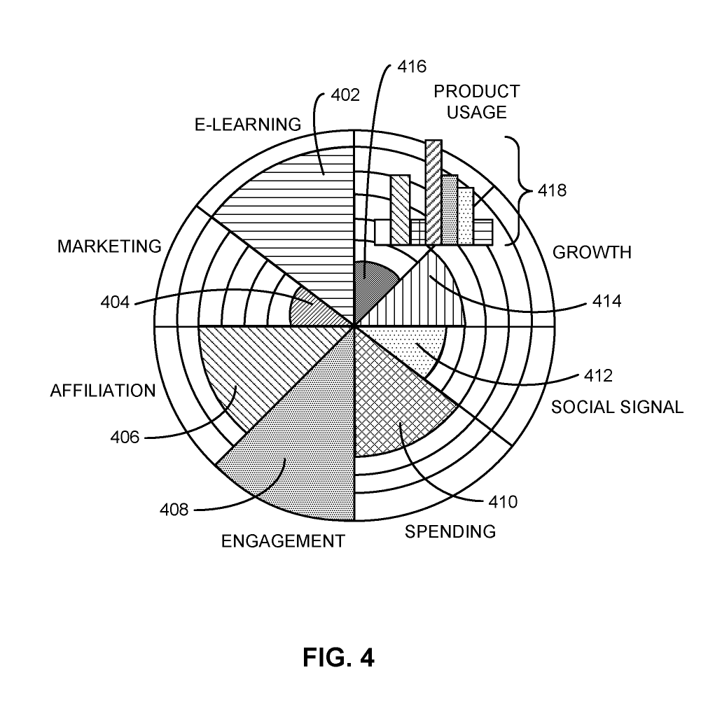

Management apparatus 204 may also output a visualization 232 associated with attributes 230. As described in further detail below with respect to FIG. 4, the visualization may include a pie chart, bar chart, and/or other chart depicting the model attributes and/or other relationships between the feature groups and the performance or output 214 of statistical model 206. In turn, the visualization may facilitate characterization of the statistical model and/or output 214 with respect to the features or feature groups, as well as the identification of additional insights related to individual features, the feature groups, and/or statistical model output.

By characterizing the performance of statistical model 206 with respect to groups of features, the system of FIG. 2 may enable feature interpretation along semantic and/or correlative lines instead of with respect to individual features, which may be affected by noise and/or correlation with other features. In turn, such analysis may scale with the number of features inputted into the statistical model; enable higher-level insights associated with the groups of features; and reduce complexity, computational overhead, and inaccuracy associated with single feature interpretation. Moreover, the use of hierarchical structure 108 to generate and select the feature groups may allow the analysis to be conducted at varying levels of granularity and/or adapted to different “views” of the statistical model.

Those skilled in the art will appreciate that the system of FIG. 2 may be implemented in a variety of ways. First, analysis apparatus 202, management apparatus 204, and/or data repository 234 may be provided by a single physical machine, multiple computer systems, one or more virtual machines, a grid, one or more databases, one or more filesystems, and/or a cloud computing system. Analysis apparatus 202 and management apparatus 204 may additionally be implemented together and/or separately by one or more hardware and/or software components and/or layers.

Second, different techniques may be used to implement statistical model 206, the view models, and/or secondary model 212. For example, the models may be implemented using artificial neural networks, Bayesian networks, support vector machines, clustering techniques, regression models, random forests, and/or other types of machine learning techniques. Moreover, the view models and/or secondary model may be selected to be the same model type or different model types from one another and/or the statistical model. For example, a random forest statistical model 206 may be characterized using view models and a secondary model that are also random forests or other types of models (e.g., linear models).

FIG. 3 shows an exemplary hierarchical structure (e.g., hierarchical structure 108 of FIG. 1) of features 302 used as input to a statistical model (e.g., statistical model 206 of FIG. 2) in accordance with the disclosed embodiments. The hierarchical structure may be used to group the features along different levels 304-310 or “tiers” of granularity, with a higher level of granularity associated with more feature groups and a fewer average number of features per group and a lower level of granularity associated with fewer feature groups and a higher average number of features per group.

As shown in FIG. 3, grouping of 10 features 302 along a highest level 304 of granularity may result in six feature groups of two features, two features, two features, one feature, two features, and one feature, respectively. Each group may be formed along semantic and/or correlative lines. For example, two features in the same group may be semantically related, may be from the same data set, and/or may be highly correlated with one another. On the other hand, a single feature that is isolated from other features in a separate feature group may lack strong semantic relationships or correlation with other features and/or be identified as an important or noteworthy feature.

The next level 306 of granularity may include four feature groups. The first feature group may combine four features in the first two feature groups from level 304, and the second feature group may combine three features in the third and fourth feature groups from level 304. The third and fourth feature groups may be the same as the fifth and sixth feature groups from level 304, respectively. By merging the first four feature groups from level 304 into two feature groups in level 306 and maintaining the same last two feature groups across both levels, the hierarchical structure may indicate that the last two feature groups are more important, less correlated, and/or more semantically distinct than the other feature groups.

The third level 308 of granularity may include three feature groups. The first two feature groups may be the same as in level 306, while the third feature group may merge the last two feature groups from levels 302 and 304. Finally, the fourth level 310 of granularity may include two feature groups, with the first feature group set to the same as the first feature group of level 308 and the second feature group set as the combination of the last two feature groups from level 308. To generate each successive level, semantic and/or correlative distinctions between pairs of feature groups in the previous level may be compared, and two or more groups from the previous level that are identified as less distinct may be merged into a larger group in the successive level.

By gradually reducing the number of feature groups across levels 304-310, the hierarchical structure may allow feature interpretation along the corresponding granularities. In turn, a given set of feature groups from one or more levels may be selected for use in characterizing the output or performance of the statistical model based on user preferences, resource constraints, and/or other criteria. For example, higher levels of granularity with more feature groups may be selected to analyze the statistical model in greater detail, while lower levels of granularity with fewer feature groups may be selected to generate an overall or “top-level” view of the model's operation. In another example, a level of granularity may be specified by a user who consumes the output of the statistical model to facilitate understanding of the output by the user. In a third example, a subset of feature groups from a given level of granularity and/or multiple feature groups from different levels of granularity may be selected for use in characterizing the performance of the statistical model.

FIG. 4 shows an exemplary screenshot in accordance with the disclosed embodiments. More specifically, FIG. 4 shows a screenshot of a visualization associated with characterizing the performance of a statistical model, such as visualization 232 of FIG. 2. As shown in FIG. 4, the visualization includes a pie chart with a number of sectors 402-416 representing groups of features in the statistical model.

Each feature group may include one or more semantically and/or otherwise related features. Sector 402 may represent features related to e-learning, sector 404 may represent features related to marketing, sector 406 may represent features related to affiliation, and sector 408 may represent features related to engagement. Sector 410 may represent features related to spending, sector 412 may represent features related to social signals, sector 414 may represent features related to growth, and sector 416 may represent features related to product usage. Consequently, the visualization of FIG. 4 may relate to a statistical model that is used to predict an attribute or behavior of a customer of a product.

Within the pie chart, the angle of each sector may represent the overall correlation between the corresponding feature group and the output of the statistical model. For example, the larger angles occupied by sectors 402 and 410 may indicate that e-learning and spending features are better correlated with the output of the statistical model, while the smaller angles occupied by sectors 404 and 412 may indicate that marketing and social signal features are less correlated with the output of the statistical model. The angle of each sector may be set based on the corresponding attribute from a secondary model (e.g., secondary model 212 of FIG. 2) used to characterize the performance of the statistical model. For example, the angle may be proportional to the impurity decrease, weight, and/or other coefficient associated with the feature group from the secondary model. Because the secondary model has the same coefficients for all sets of features, the angles of sectors 402-416 may remain the same across different sets of features inputted into the statistical model.

The amount by which a sector extends from the center of the pie chart may reflect the effect of specific values in the feature group on the output of the statistical model. For example, the extension of sectors 402 and 408 to or near the edge of the pie charge may indicate that values of the e-learning and engagement features for a specific customer have contributed significantly to the statistical model's outputted prediction, estimate, and/or other inference related to the customer. Conversely, the relative lack of extension of sectors 404, 412 and 416 may indicate that values of the marketing, social signal, and product usage features do not contribute much to the statistical model's output regarding the customer. The extension of each sector in the pie chart may be proportional to the output of the view model for the corresponding feature group, which may or may not be adjusted or calibrated to better reflect the output of the statistical model.

The visualization of FIG. 4 additionally includes a bar chart 418 associated with sector 416. For example, the bar chart may be display when a user clicks, hovers a cursor over, and/or otherwise interacts with sector 416 and/or data associated with sector 416. Bars in the bar chart may indicate the relative importance of individual features in the corresponding feature group (e.g., product usage). For example, the height of each bar may be proportional to the coefficient and/or weight of the corresponding feature in a view model for the feature group. The position and/or composition of the bar chart may also be updated to reflect features in other feature groups based on user input associated with the corresponding sectors of the pie chart and/or feature groups.

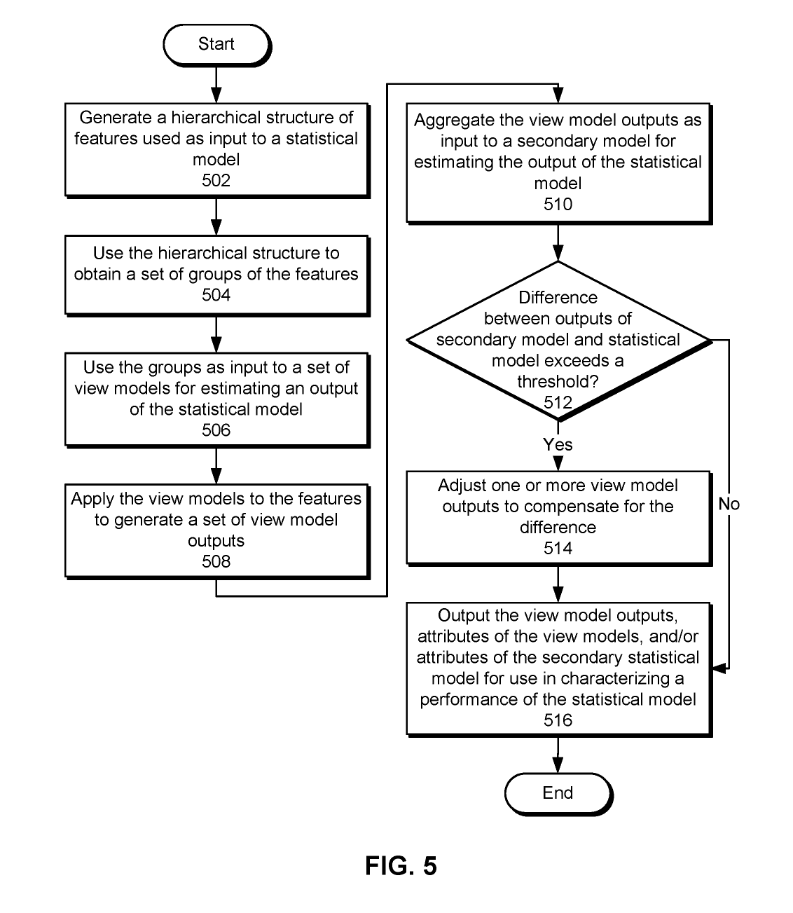

FIG. 5 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

Initially, a hierarchical structure of features used as input to a statistical model is generated (operation 502). The hierarchical structure may include multiple “tiers” or levels representing different granularities by which the features are grouped. Within a given tier, the features may be grouped based on correlations among the features. For example, the features may be grouped to increase correlation among features within a group and decrease correlation across groups. The features may also, or instead, include semantic groupings that are derived from business concerns, metadata, different sources of the features, and/or types or meanings associated with the features.

Next, the hierarchical structure is used to obtain a set of groups of the features (operation 504). For example, a level of granularity associated with the hierarchical structure (e.g., number of feature groups, average number of features per group, tier of the hierarchical structure) may be selected and used to obtain the feature groups.

The groups of features are used as input to a set of view models for estimating an output of the statistical model (operation 506). For example, each view model may be trained using values of a corresponding group of features to estimate the output of the statistical model. After the view models are produced, the view models are applied to the features to generate a set of view model outputs (operation 508). Each view model output may represent the effect of the corresponding group of features on the output of the statistical model. For example, a higher view model output may indicate a stronger effect of a specific set of values in the feature group on the output of the statistical model, while a lower view model output may indicate a weaker effect of the values on the statistical model output.

The view model outputs are then aggregated as input to a secondary model for estimating the output of the statistical model (operation 510). For example, the view models may be used to transform a large number of features into a lower-dimensional feature space, with each coordinate of the feature space representing a given feature group or “view” of the statistical model. Values outputted by the view models may then be used to train the secondary model so that the secondary model estimates the output of the statistical model.

The difference between the output of the secondary model and the output of the statistical model may exceed a threshold (operation 512). For example, the threshold may be calculated based on quantiles from a distribution of the difference. When the difference exceeds the threshold, one or more view model outputs are adjusted to compensate for the difference (operation 514). Continuing with the previous example, if a given output of the secondary model differs from the corresponding output of the statistical model by more than 50% of the average difference between the two outputs, some or all outputs of the view models may be adjusted (e.g., iteratively and/or using a regression technique) until the difference falls below the threshold.

Finally, the view model outputs, attributes of the view models, and/or attributes of the secondary model are outputted for use in characterizing the performance of the statistical model (operation 516). For example, the outputs and/or attributes may be displayed and/or exported for viewing by users that consume the output of the statistical model. Each view model output may represent the contribution of the corresponding group of feature values on the output of the statistical model, each weight or coefficient in a view model may represent the correlation between a specific feature and the output of the statistical model, and each weight or coefficient in the secondary model may represent the correlation between a corresponding feature group and the output of the statistical model. In another example, the outputs and/or attributes may be used to generate a visualization, such as the visualization of FIG. 4. In turn, the outputted values and/or visualization may facilitate understanding of the performance and output of the statistical model, as well as the gleaning of insights related to the features, feature groups, and/or statistical model.

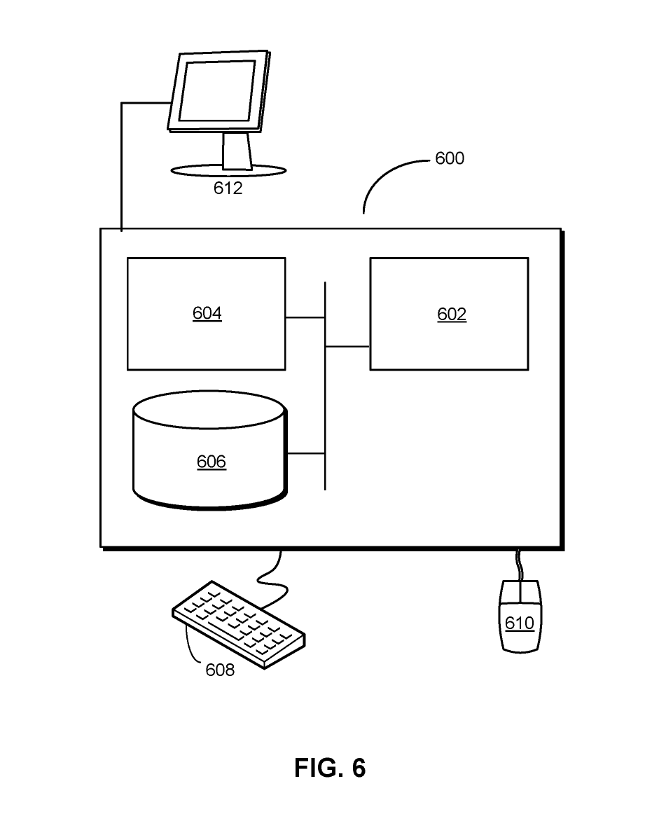

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system may include an analysis apparatus and a management apparatus, one or both of which may alternatively be termed or implemented as a module, mechanism, or other type of system component. The analysis apparatus may use a hierarchical structure of features inputted into a statistical model to obtain a set of groups of the features. Next, the analysis apparatus may use the groups to produce a set of view models for estimating an output of the statistical model, with each group of features used as input to a different view model. The analysis apparatus may then apply the view models to the features to generate a set of view model outputs, such that each view model output represents an effect of the corresponding group of features on the output of the statistical model. Finally, the management apparatus may output the view model outputs for use in characterizing the performance of the statistical model.

In addition, one or more components of computer system 600 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that uses a hierarchical structure of features to characterize the output or performance of a remote statistical model.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
using a hierarchical structure of features inputted into a statistical model to obtain a set of groups of the features;
using the groups as input to a set of view models for estimating an output of the statistical model;
applying, by one or more computer systems, the view models to the features to generate a set of view model outputs, wherein each view model output in the set of view model outputs represents an effect of a group in the set of groups on the output of the statistical model; and
outputting the view model outputs for use in characterizing a performance of the statistical model.

2. The method of claim 1, further comprising:
aggregating the view model outputs as input to a secondary statistical model for estimating the output of the statistical model; and
using one or more attributes of the secondary statistical model to further characterize the effect of the groups on the output of the statistical model.

3. The method of claim 2, further comprising:
when a difference between a secondary output of the secondary statistical model and the output of the statistical model exceeds a threshold, adjusting one or more of the view model outputs to compensate for the difference.

4. The method of claim 2, wherein the one or more attributes comprise a set of weights associated with the set of groups.

5. The method of claim 1, further comprising:
generating the hierarchical structure of features.

6. The method of claim 5, wherein the hierarchical structure is generated based on correlations among the features.

7. The method of claim 6, wherein the hierarchical structure is generated to increase correlations of features within a group and decrease correlations among the groups.

8. The method of claim 5, wherein the hierarchical structure is generated based on semantic groupings of the features.

9. The method of claim 1, wherein using the hierarchical structure to obtain the set of groups of the features comprises:
selecting a level of granularity associated with the hierarchical structure; and
using the level of granularity to obtain the set of groups of the features.

10. The method of claim 1, further comprising:
using a set of attributes of the view models to further characterize an effect of the features on the output of the statistical model.

11. The method of claim 1, wherein outputting the view model outputs for use in characterizing the performance of the statistical model comprises:
displaying a visualization comprising representations of the groups; and
adjusting, in the visualization, the representations to reflect the view model outputs.

12. An apparatus, comprising:
one or more processors; and
memory storing instructions that, when executed by the one or more processors, cause the apparatus to:
use a hierarchical structure of features inputted into a statistical model to obtain a set of groups of the features;
use the groups as input to a set of view models for estimating an output of the statistical model;
apply the view models to the features to generate a set of view model outputs, wherein each view model output in the set of view model outputs represents an effect of a group in the set of groups on the output of the statistical model; and
output the view model outputs for use in characterizing a performance of the statistical model.

13. The apparatus of claim 12, wherein the memory further stores instructions that, when executed by the one or more processors, cause the apparatus to:
aggregate the view model outputs as input to a secondary statistical model for estimating the output of the statistical model; and
use one or more attributes of the secondary statistical model to further characterize the effect of the groups on the output of the statistical model.

14. The apparatus of claim 13, wherein the memory further stores instructions that, when executed by the one or more processors, cause the apparatus to:
when a difference between a secondary output of the secondary statistical model and the output of the statistical model exceeds a threshold, adjust one or more of the view model outputs to compensate for the difference.

15. The apparatus of claim 12, wherein the memory further stores instructions that, when executed by the one or more processors, cause the apparatus to:
generate the hierarchical structure of features.

16. The apparatus of claim 15, wherein the hierarchical structure is generated based on at least one of:
correlations among the features; and
semantic groupings of the features.

17. The apparatus of claim 12, wherein the memory further stores instructions that, when executed by the one or more processors, cause the apparatus to:
use a set of attributes of the view models to further characterize an effect of the features on the output of the statistical model.

18. The apparatus of claim 12, wherein using the hierarchical structure to obtain the set of groups of the features comprises:
selecting a level of granularity associated with the hierarchical structure; and
using the level of granularity to obtain the set of groups of the features.

19. A system, comprising:
an analysis module comprising a non-transitory computer-readable medium storing instructions that, when executed, cause the system to:
use a hierarchical structure of features used inputted into a statistical model to obtain a set of groups of the features;
use the groups to as input to a set of view models for estimating an output of the statistical model; and
apply the view models to the features to generate a set of view model outputs, wherein each view model output in the set of view model outputs represents an effect of a group in the set of groups on the output of the statistical model; and
a management module comprising a non-transitory computer-readable medium storing instructions that, when executed, cause the system to output the view model outputs for use in characterizing a performance of the statistical model.

20. The system of claim 19, wherein the non-transitory computer-readable medium of the analysis module further stores instructions that, when executed, cause the system to:
aggregate the view model outputs as input to a secondary statistical model for estimating the output of the statistical model; and
use one or more attributes of the secondary statistical model to further characterize the effect of the groups on the output of the statistical model.
